(19) United States
(12) Patent Application Publication
(10) Pub. No.: US 2015/0180583 A1
(43) Pub. Date: Jun. 25, 2015

(54) WAVELENGTH DIVISION MULTIPLEXING OPTICAL TRANSMISSION DEVICE

(71) Applicant: NEC CORPORATION, Tokyo (JP)

(72) Inventor: Takeshi Nakata, Tokyo (JP)

(73) Assignee: NEC CORPORATION, Tokyo (JP)

(21) Appl. No.: 14/416,840

(22) PCT Filed: Jul. 24, 2013
(86) PCT No.: PCT/JP2013/004492

§ 371 Date: Jan. 23, 2015

(30) Foreign Application Priority Data
Jul. 25, 2012 (JP) 2012-164258

(51) Int. Cl. H04B 10/564; H04J 14/02; H04B 10/079

(52) U.S. Cl. CPC H04B 10/564; H04B 10/07955; H04J 14/0221

(57) ABSTRACT

[Problem] In relation to optical communication of a wavelength-division multiplex method, provided is an an optical transmission device capable of performing transmission of an optical signal wherein the influence of waveform distortion or the like generated when the optical signal passes through a device or the like on a transmission line is suppressed, and deterioration of waveform is accordingly small.

[Means for solution] The optical transmission device comprises a multiplexing means 80, an amplification means 81 and an optical signal correction means 82. The multiplexing means 80 multiplexes together optical signals inputted to it by means of paths in accordance with respective channels of the optical signals, and outputs thus produced signal as a multiplexed signal. The amplification means 81 amplifies the multiplexed signal and outputs thus produced signal as an amplified signal. The optical signal correction means 82 corrects the amplified signal in terms of each channel and outputs thus produced signal as a corrected signal. By sequentially connecting the multiplexing means 80, the amplification means 81 and the optical signal correction means 82 in this order, the influence of waveform distortion of an optical signal or the like can be suppressed.

### TECHNICAL FIELD

The present invention is a technology related to optical communications, and in particular, to an optical transmission device which transmits optical signals of a wavelength division multiplexing method.

### BACKGROUND ART

In association with the development of the information and telecommunications society, the communication amount has been dramatically increased, and the role of a high-speed, high-capacity communication channel has become large. There, an optical communication channel has a particularly important role among others, and development of technologies related to it has been extensively conducted. As one of communication technologies for achieving an increased capacity, a technology of transmitting coded signals in a multiplexed form is sometimes used. Also in the field of optical telecommunications, already used is a wavelength division multiplexing (WDM) method which assigns a wavelength to each of coded signals and transmits optical signals of the respective wavelengths in a multiplexed form.

In an optical communication channel, an optical signal is transmitted via various devices such as a relay and an amplifier on a transmission line. On a transmission line, there occurs not only attenuation of the intensity of an optical signal but also deterioration in a signal waveform resulting from that wavelength dependence is different for each material and each connection part. In a wavelength division multiplexing method, in order to multiplex as many optical signals as possible in a fixed bandwidth, the wavelength intervals to be set need to be made small. However, when the wavelength intervals between the signals are small, the influence of deterioration of the optical signals becomes more likely to occur. On the other hand, in order to perform information transmission correctly, it is necessary to suppress deterioration of the optical signals into within a designed range which is assumed in advance at the receiving side. In an optical signal transmission line, deterioration of an optical signal, accumulation of noise, and the like cause deterioration in the ratio of the optical signal to noise, that is, the optical signal to noise ratio (OSNR). In order to suppress deterioration of an optical signal to be received and deterioration in its OSNR caused by the optical signal deterioration itself and the other factors described above into within a designed range, optical signal correction is sometimes performed in the middle of a transmission line, and a technology of performing optical signal correction at each transmission device has been developed. For example, Patent Literature 1 (PTL 1) describes a technology in which a transmission device used as a relay performs optical signal correction.

The transmission device of PTL 1 is composed of an amplifier installed in an input section, an optical add/drop multiplexer (OADM), an optical attenuation means and an amplifier installed in an output section. The transmission device of PTL 1 comprises a means for measuring the intensity of an optical signal at the output side of the amplifier installed in the output section. The transmission device of PTL 1 further comprises a means for controlling the amount of attenuation given by the optical attenuation means and the intensity of an optical signal outputted by the optical add/drop multiplexer to a transmission line, on the basis of a result of the optical signal intensity measurement. Of an optical signal inputted via the input section, the intensity is adjusted by the optical attenuation means, and thus, the optical signal is adjusted in its intensity before being inputted to the optical add/drop multiplexer. PTL 1 describes that, by performing the adjustment in a manner to control each signal to be outputted with a predetermined intensity from the transmission device, transmission of optical signals can be performed with the output being kept constant.

The transmission device of Patent Literature 2 (PTL 2) is composed of a demultiplexer, a means for adjusting each of the demultiplexed optical signals, and a multiplexer which multiplexes the adjusted optical signals together. There, the intensity of an optical signal is measured in terms of each wavelength before the optical signal enters the demultiplexer, and then after the optical signal is demultiplexed, each of the demultiplexed optical signals is adjusted on the basis of the measurement result and is multiplexed with the others again. PTL 2 describes that, by performing the adjustment after determining appropriate adjustment amounts in accordance with the respective optical signals, it becomes possible to transmit optical signals being different in modulation method, bit rate or the like in a multiplexed form.

### CITATION LIST

### Patent Literature

[PTL 1] Japanese Patent Application Laid-Open No. 2002-185407

[PTL 2] Japanese Patent Application Laid-Open No. 2007-235412

### SUMMARY OF INVENTION

### Technical Problem

However, the technology disclosed in PTL 1 has the following problem. In the optical transmission device of PTL 1, an optical signal attenuated by the optical attenuation means and an optical signal from the optical add/drop multiplexer are both inputted to the amplifier on the output side. There, because the optical signal attenuated by the optical attenuation means is inputted to the amplifier with no correction made to its waveform, noise on the path also is amplified and then accumulated. For this reason, at a time of an optical signal's reaching at a receiving side device to be their sending destination, there may be a case where deterioration in OSNR becomes large owing to the noise accumulation or the like, and as a result, the receiving side device cannot receive the optical signal correctly.

The optical transmission device of PTL 2 analyzes the waveform of an optical signal before amplification and demultiplexing, and thereby performs correction of optical signals of respective wavelength after demultiplexing. Accordingly, there may be a case where noise generated by the amplifier and a waveform distortion enhanced by the amplification are outputted, as they are, without being recognized. As a result, there may be a case where waveform distortions are accumulated as transmission of an optical signal progresses on the transmission line, and accordingly, the optical signal cannot be correctly received at a receiving side.

The objective of the present invention is to achieve an optical transmission device which can suppress the influence of such as waveform distortion of an optical signal to occur when the optical signal passes through a device on a transmission line, or the like, and accordingly can perform optical signal transmission with small deterioration in waveform and in OSNR.

### Solution to Problem

In order to solve the above-described problem, an optical transmission device of the present invention comprises a multiplexing means, an amplification means and an optical signal correction means. The multiplexing means multiplexes optical signals inputted to it by means of paths in accordance with respective channels of the optical signals and outputs thus produced signal as a multiplexed signal. The amplification means amplifies the multiplexed signal and outputs thus produced signal as an amplified signal. The optical signal correction means performs correction of the amplified signal in terms of each channel and outputs thus produced signal as a corrected signal.

An optical signal transmission method of the present invention comprises: multiplexing inputted optical signals by means of paths in accordance with respective channels of the optical signals and then outputting thus produced signal as a multiplexed signal; and amplifying the multiplexed signal and then outputting thus produced signal as an amplified signal. The optical signal transmission method of the present invention further comprises performing correction of the amplified signal in terms of each channel and then outputting thus produced signal as a corrected signal.

### Advantageous Effects of Invention

According to the present invention, by inputting signals to the multiplexing means, the amplification means and the optical signal correction means in this order, it is possible to suppress the influence of signal deterioration such as waveform distortion of an optical signal and deterioration in OSNR. As a result, it becomes possible to perform optical signal transmission with small waveform distortion of an optical signal and small deterioration in OSNR, and the quality of communication is accordingly increased.

### BRIEF DESCRIPTION OF DRAWINGS

FIG. 1 a diagram showing an outline of a configuration in a first exemplary embodiment of the present invention.

FIG. 2 a diagram showing a part of the configuration in the first exemplary embodiment of the present invention.

FIG. 3 a diagram showing a part of the configuration in the first exemplary embodiment of the present invention.

FIG. 4 a diagram showing examples of optical signal output levels in the present invention.

FIG. 5 a diagram showing an outline of a configuration in a second exemplary embodiment of the present invention.

FIG. 6 a diagram showing a part of the configuration in the second exemplary embodiment of the present invention.

FIG. 7 a diagram showing an example of an optical signal waveform in the present invention.

FIG. 8 a diagram showing an example of an optical signal waveform in the present invention.

FIG. 9 a diagram showing an example of a configuration of an optical transmission device of the present invention.

FIG. 10 a diagram showing an example of a configuration of an optical transmission device of the present invention.

FIG. 11 a diagram showing an outline of a configuration in a third exemplary embodiment of the present invention.

### DESCRIPTION OF EMBODIMENTS

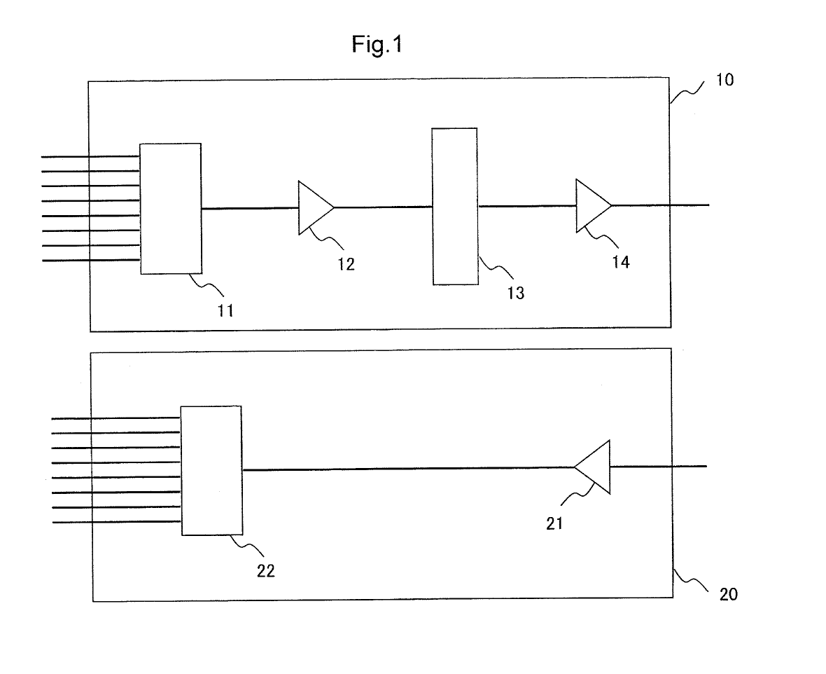

A first exemplary embodiment of the present invention will be described in detail, with reference to FIG. 1. FIG. 1 is a diagram showing an outline of a configuration of an optical transmission device according to the present exemplary embodiment. The optical transmission device of the present exemplary embodiment consists of a multiplexing unit 10 and a demultiplexing unit 20.

The multiplexing unit 10 comprises a multiplexer 11, a first amplifier 12 which amplifies a multiplexed optical signal, a wavelength blocker 13 which performs correction of an optical signal from the first amplifier 12, and a second amplifier 14 which amplifies an output signal from the wavelength blocker 13. Each component is connected to each other by means of optical fibers.

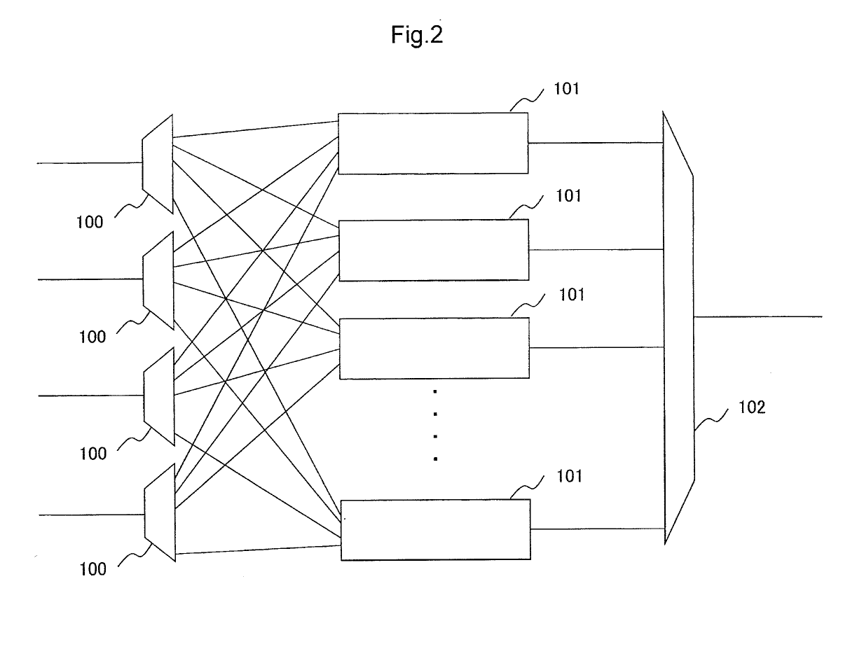

A wavelength selective switch (WSS) is used as the multiplexer 11. FIG. 2 shows an outline of a configuration of the multiplexer 11. The wavelength selective switch used as the multiplexer 11 is composed of demultiplexing elements 100 each of which demultiplexes an optical signal, switch elements 101 each having a function to select and output one of optical signals inputted to it, and a multiplexing element 102 having a function to multiplex optical signals together. Each of the demultiplexing elements 100 demultiplexes an optical signal, inputted to it in a multiplexed form, into optical signals of respective channels. Here, the channels are referred to as, with respect to a case an optical signal is separated in terms of predetermined bands, the individual predetermined bands and optical signals included in the respective bands. The predetermined bands are set to be constant or variable in accordance with a network design or the like.

The optical signals separated from each other in terms of the channels, which have been produced by the demultiplexing performed by each of the demultiplexing elements 100, are inputted to the switch elements 101 being assigned to the respective channels. Each of the switch elements 101 can select and output a necessary signal for each of the channels, from among optical signals inputted to it from the plurality of demultiplexing elements 100. At that time, only one optical signal is selected for each of the channels. This is sometimes referred to as contention. The multiplexing element 102 demultiplexes optical signals of the respective channels each selected by the corresponding one of the switch elements 101, and outputs thus produced optical signal.

For the demultiplexing elements 100 and the multiplexing element 102, a diffraction grating, a prism or the like may be used. An arrayed waveguide grating (AWG) also may be used as the demultiplexing elements 100 and the multiplexing elements 102. For the switch elements 101, an MEMS (Micro-Electro-Mechanical System) technology and an LCOS (Liquid Crystal On Silicon) technology are used, for example. An LC (Liquid Crystal) device technology and a DLP (Digital Light Processing) device technology also may be used for the switch elements 101. The switch elements 101 may be constructed by combining the above-mentioned elements or technologies. By using the combination of the demultiplexing elements 100, the switch elements 101 and the multiplexing element 102, it is possible to select, from among optical signals inputted from a plurality of paths, a necessary signal for each channel and output the selected signals in the form of a multiplexed signal.

When optical signals pass through the multiplexer 11, each of the optical signals is demultiplexed by the corresponding one of the demultiplexing elements 100 into optical signals of the respective channels, that is, optical signals of respective ones of the predetermined wavelength bands. Then, the optical signals are inputted to the switch elements 101 assigned to the respective channels, and necessary ones of the optical signals are selected by the switch elements 101 and then multiplexed together by the multiplexing element 102. Thus, when passing through the multiplexer 11, optical signals are each demultiplexed in terms of each channel, travel through predetermined paths in accordance with the respective channels, and are subsequently multiplexed together. As a result, passing through the multiplexer 11, inputted optical signals are transformed into a multiplexed optical signal which, with respect to each of the optical signals of the respective channels having been multiplexed into it, includes no signals outside the corresponding predetermined wavelength band.

As the first amplifier 12A, a fixed gain amplifier (FGA) is used. For the fixed gain amplifier, an erbium doped fiber amplifier (EDFA) may be used, for example. For the second amplifier 14, an element similar to that for the first amplifier 12 may be used.

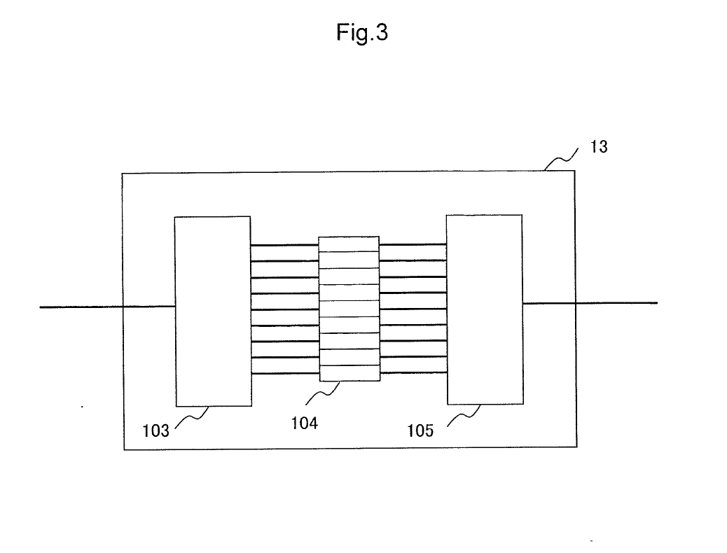

The wavelength blocker 13 has a filter function to attenuate an optical signal outside a predetermined wavelength region, and also a function to attenuate an optical signal within the predetermined wavelength region. FIG. 3 shows an outline of a configuration of the wavelength blocker 13. The wavelength blocker 13 is composed of a first diffraction grating 103, a variable optical attenuator (VOA) unit 104 and a second diffraction grating 105. The wavelength blocker 13 demultiplexes an optical signal by means of the first diffraction grating 103, and then performs correction of each of the demultiplexed signals, by the use of a function of the variable optical attenuator unit 104 which can perform adjustment, such as attenuation, separately on each of optical signals of respective channels. After the adjustment such as attenuation, the optical signals of respective channels are multiplexed together by the second diffraction grating 105, and then outputted from the wavelength blocker 13. As the variable optical attenuator unit 104, for example, one using the optical shutter function of liquid crystal elements may be used. In that case, the liquid crystal elements are formed on respective paths for the signals of respective channels. In the example using the liquid crystal elements, the adjustment is performed in terms of each channel by the use of a mechanism where the orientation of each liquid crystal layer is changed by voltage application to the liquid crystal layer and the optical transmittance accordingly changes in a continuous manner.

The demultiplexing unit 20 comprises an amplifier 21 and a demultiplexer 22. The amplifier 21 and the demultiplexer 22 are connected with each other via an optic fiber. An element similar to that for the first amplifier 12 may be used for the amplifier 21. The demultiplexer 22 comprises an arrayed waveguide grating, a matrix-shaped switch element and so on. An optical signal inputted from the amplifier 21 to the demultiplexer 22 is demultiplexed by the arrayed waveguide grating in terms of each wavelength, that is, in terms of each channel. The demultiplexed signals are guided to respective ones of predetermined paths and outputted, by the switch element. There may be a case where, after the switch element's selecting paths for respective ones of the demultiplexed optical signals, the optical signals pass through multiplexing elements provided separately for the respective paths, and then are outputted, each in a multiplexed form, separately from the respective paths.

In a case such as where, in the multiplexing unit 10 and the demultiplexing unit 20, the constituent elements are formed into a single device, connection paths between the elements may be made not only by optical fibers but also by another type of optical paths.

Next, a description will be given of operation of the demultiplexing unit 20 in the optical transmission device of the present exemplary embodiment. An optical signal is inputted from a transmission line to the demultiplexing unit 20. The optical signal inputted to the demultiplexing unit 20 is amplified by the amplifier 21, in order to compensate for a loss generated at the transmission line. The optical signal amplified by the amplifier 21 is sent to the demultiplexer 22. The optical signal inputted from the amplifier 21 to the demultiplexer 22 is sent to the arrayed waveguide grating, where it is demultiplexed in terms of each wavelength, that is, in terms of each channel. The optical signals of respective channels produced by the demultiplexing are guided by the switch element to paths corresponding to the respective wavelength, and thereby outputted from the demultiplexing unit 20. There may be a case where the optical signals of respective channels produced by the demultiplexer 22 are outputted to the respective paths in a state of being multiplexed for each path.

In the demultiplexing unit 20, an optical splitter may be used instead of the demultiplexer 22. In that case, an optical signal is not demultiplexed by the demultiplexing unit 20, but is split by the optical splitter into optical signals directed to a plurality of paths and then outputted from the demultiplexing unit 20. In the case where an optical signal is outputted after only being split by the optical splitter, selection of a necessary optical signal is performed by such as a wavelength selective switch of a multiplexing unit in an opposing optical transmission device. Also a wavelength selective switch or the like may be used for the demultiplexer 22.

Next, a description will be given of operation of the multiplexing unit 10 in the optical transmission device of the present exemplary embodiment. Optical signals are inputted from respective paths to the multiplexing unit 10. The optical signals of the respective paths inputted to the multiplexing unit 10 are demultiplexed by respective ones of the demultiplexing elements 100 in the multiplexer 11, and the demultiplexed signals are inputted to the switch elements 101 corresponding to respective channels. After necessary optical signals for respective channels are selected by the switch elements 101, the selected optical signals are multiplexed together by the multiplexing element 102 into a multiplexed optical signal. The multiplexed optical signal is outputted from the multiplexer 11 and sent to the first amplifier 12, where it is amplified. The optical signal amplified by the first amplifier 11 is sent to the wavelength blocker 13. In the wavelength blocker 13, the amplified optical signal is demultiplexed again within the inside in terms of each wavelength, that is, in terms of each channel, and the demultiplexed signals are subsequently subjected to a predetermined attenuation process. The predetermined attenuation process is referred to as, for example, a process of correcting the optical signals by performing a filtering process of cutting off a signal outside a band which is set for each channel, a process of attenuating a signal within the band set for each channel, or the like. There may be also a case where a level equalization process between the signals is performed. The optical signals having received the predetermined attenuation process are multiplexed together again, and then outputted from the wavelength blocker 13. The optical signal outputted from the wavelength blocker 13 is amplified by the second amplifier 14, and subsequently outputted from the multiplexing unit 10 and sent to a transmission line.

In the wavelength selective switch, optical signals of respective ones of predetermined bands, that is, of the respective channels, which have been produced by the demultiplexing performed by the demultiplexing elements 100, pass through the switch elements 101 and then are multiplexed together by the multiplexing element 102. When the optical signals of the respective channels produced by the demultiplexing elements 100 are inputted to the switch elements 101, portion of each of the optical signals outside a band of the corresponding channel is not inputted to the corresponding switch element 101. Therefore, the wavelength selective switch has a filter function of preventing a signal outside a certain band from passing through it. As a result of the filter function of the wavelength selective switch, in the optical transmission device of the present exemplary embodiment, optical signals of respective wavelength, that is, of respective channels, which are inputted from the transmission lines, are multiplexed together in a state where the signal intensity outside a certain band has been attenuated for each of the channels. As a result, each of the signals inputted from the transmission lines becomes in a state with its crosstalk having been removed, and accordingly does not have influence on signals of the other channels. Noise in the optical signals of respective channels also is removed, and accordingly, the multiplexed optical signal becomes that with low noise. While the multiplexed optical signal is amplified by the amplifier, noise after the amplification also is suppressed, because the amplification is performed on the basis of the optical signal in a low noise state. Because correction of the optical signal by the wavelength blocker is performed on the basis of the optical signal having been amplified in a low noise state, it becomes possible to perform the correction process accurately. By performing the above-described processes, the optical signal quality can be increased in the optical transmission device of the present exemplary embodiment.

The wavelength selective switch used as the multiplexer 11, the wavelength blocker 13 and the like are ones which may be a lossy medium for optical signals. If, differently from the present exemplary embodiment, the configuration is made such that the multiplexer 11 and the wavelength blocker 13 are formed into a single component with no amplifier provided between them, the total insertion loss for an optical signal becomes large. As a result, the intensities, that is, the power levels, of optical signals of respective channels are likely to be low, and deterioration of an outputted optical signal in its OSNR is likely to occur.

On the one hand, by using the multiplexer 11, the first amplifier 12 and the wavelength blocker 13 in this order, as in the present exemplary embodiment, a minimum of the intensities of optical signals of respective channels within the device can be improved. That is, by employing the configuration of the present exemplary embodiment, it becomes possible to keep larger a minimum of the intensities of optical signals of respective channels within the device, compared to the case of comprising no amplifier. Because the OSNR depends strongly on a minimum of the intensities of optical signals of respective channels within the device, the OSNR can be improved by increasing the minimum. Therefore, by employing the configuration of the present exemplary embodiment, the OSNR can be improved compared to the case of comprising no amplifier. These effects become particularly significant in a transmission path set to run through a plurality of optical transmission devices, because the improvement effect is accumulated at every passing through one optical transmission device.

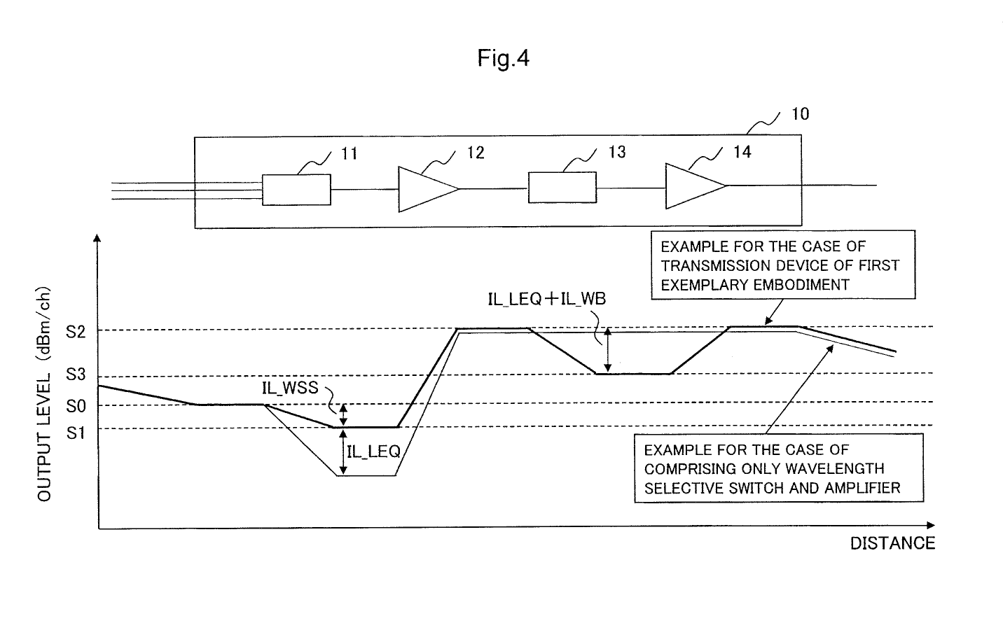

Here, a comparison will be made between the optical transmission device of the present exemplary embodiment and an optical transmission device which is composed of only the wavelength selective switch and the amplifier and accordingly performs signal correction by means of a level equalization process performed by the wavelength selective switch. FIG. 4 schematically shows the levels of an optical signal after its passing through each of the components in the case of the present exemplary embodiment and in the case of being composed of only the wavelength selective switch and the amplifier. The horizontal axis, that is, the distance axis, of FIG. 4 represents locations in the multiplexers 10 of the optical transmission devices, and the corresponding components of the multiplexers 10 are shown above the graph. The optical signal level at a time of being inputted to the optical signal wavelength selective switch is assumed to be S0 (dBm/ch). Also assumed is that the insertion loss in the wavelength selective switch is IL_WSS (dB), the level of output from the wavelength selective switch is S1 (dBm/ch) and the level after amplification by the first amplifier is S2 (dBm/ch). Further assumed is that the insertion losses in the wavelength blocker is IL_WB (dB), the magnitude of attenuation induced by the level equalization performed by the wavelength blocker is IL_LEQ (dB) and the output level of the wavelength blocker is S3 (dBm/ch).

In the optical transmission device which performs level equalization by means of the wavelength selective switch, an optical signal whose level is S0 (dBm/ch) at the time of its input comes to have a level of S0−IL_WSS−IL_LEQ (dBm/ch) at the time of its output from the wavelength selective switch, being influenced by the insertion loss and the attenuation process in the level equalization. On the other hand, in the optical transmission device of the present exemplary embodiment, the signal level at the time of signal output from the wavelength selective switch becomes S0−IL_WSS (dBm/ch), because no attenuation process is performed by the wavelength selective switch. Accordingly, the signal level at the time of signal output from the wavelength selective switch is higher by IL_LEQ (dB) for the present exemplary embodiment.

In the optical transmission device of the present exemplary embodiment, the signal level at the time of signal output from the wavelength blocker becomes S2−IL_WB−IL_LEQ (dBm/ch). With regard to S2, for example, in order to secure a signal level of −1.0 dBm/ch output in a system which amplifies a wavelength division multiplex signal of 100 channels, a WDM fixed gain amplifier with +19.0 dBm total power is required. A WDM fixed gain amplifier with about +19.0 dBm total power is commercially available. The WDM fixed gain amplifier is referred to as an optical amplifier which is adjusted to have a constant gain in a certain wavelength range in the C band, L band or the like. When an optical amplifier with +21.0 dBm total power is used, the magnitude of S2 becomes +1.0 dBm/ch in a 100 channel system, +2.0 dBm/ch in a 80 channel system, and +5.0 dBm/ch in a 40 channel system.

It is assumed that, in a 100 channel system, an optical amplifier with 21.0 dBm total power is used as the first amplifier 12, and S2 is +1.0 dBm/ch. Also assumed is that a commercially available wavelength blocker having an insertion loss IL_WB of +6.0 dB is used as the wavelength blocker 13, and IL_LEQ is set at 2.0 dB. In that case, the signal level at the output section of the wavelength blocker S3=S2−IL_WB−IL_LEQ (dBm/ch) becomes −7.0 dBm/ch. If considering a case the output level at the wavelength blocker S3 becomes higher than that at the wavelength selective switch S1, S1<S3=S2−IL_WB−IL_LEQ=−7.0 dBm/ch stands. Then, because S1=S0−IL_WSS (dBm/ch), S0−IL_WSS<−7.0 dBm/ch stands. When a wavelength selective switch with 6.0 dB insertion loss is used as the wavelength selective switch, S0<−1.0 dBm/ch is obtained.

When a WDM fixed gain amplifier with +19.0 dBm total power is used as the first amplifier, as S2 is assumed to be −1.0 dBm/ch, the signal level at the output section of the wavelength blocker S3=S2−IL_WB−IL_LEQ becomes −9.0 dBm/ch. If calculating similarly with +19.0 dBm total power, S0<−3.0 dBm/ch is obtained. Therefore, when the configuration of the optical transmission device of the present exemplary embodiment is used, a high signal level can be maintained even when the level of an input signal is low, with no necessity for increasing the output level of the first amplifier 12.

By using the optical transmission device of the first exemplary embodiment, it becomes possible to suppress the influence of signal deterioration, such as waveform distortion of an optical signal and degradation in its OSNR, generated at a time of transmitting the optical signal. This effect is brought about by removing noise or the like included in an optical signal by means of a filtering characteristic realized by the multiplexing means having paths for respective channels, amplifying the optical signal in a state the noise or the like has been removed, and then performing correction of the optical signal. By thus performing correction of an optical signal in a state with a smaller amount of noise, accuracy of the signal correction is increased. As a result, the influence of accumulation of noise or the like at a time of an optical signal's passing through the optical transmission device is decreased, it accordingly becomes possible to transmit an optical signal in a state where waveform distortion of the optical signal, deterioration in its OSNR and the like are small, and the quality of communication is accordingly increased.

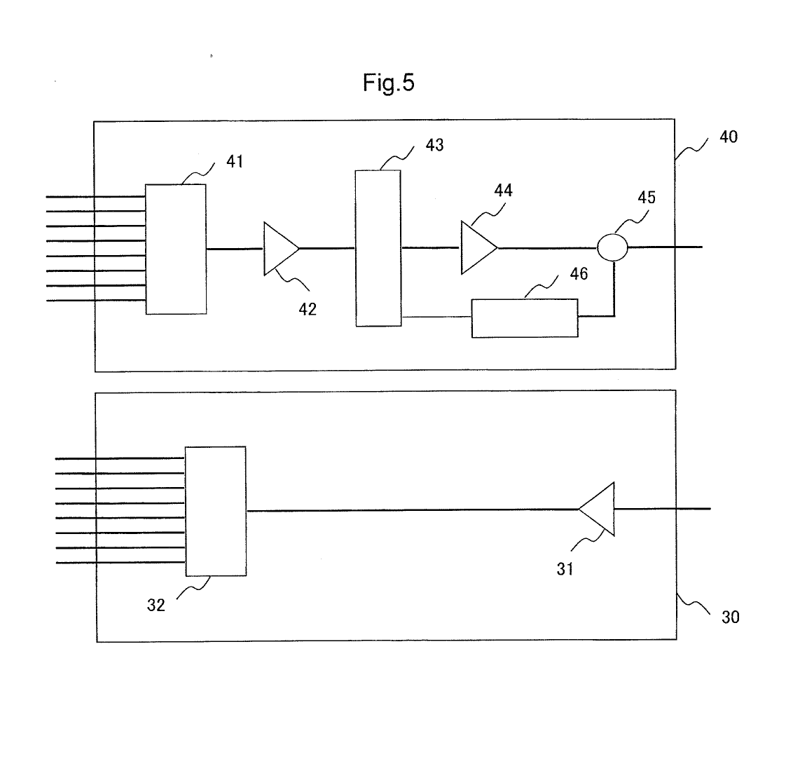

Next, a second exemplary embodiment of the present invention will be described in detail, with reference to FIG. 5. FIG. 5 is a diagram showing an outline of a configuration of an optical transmission device in the present exemplary embodiment. The optical transmission device of the present exemplary embodiment is characterized by that it measures the output level of an optical signal and performs signal correction on the basis of the measurement result.

The optical transmission device of the present exemplary embodiment consists of a demultiplexing unit 30 and a multiplexing unit 40.

The demultiplexing unit 30 comprises an amplifier 31 which amplifies an optical signal inputted from a transmission line and a demultiplexer 32 which demultiplexes the amplified optical signal into signals of respective wavelengths. The configuration and the function of the demultiplexing unit 30 are the same as those of the constituent given the same name in the first exemplary embodiment.

The multiplexing unit 40 comprises a multiplexer 41, a first amplifier 42, a wavelength blocker 43, a second amplifier 44, a branching unit 45 and an output measurement device 46. The configurations and the functions of the multiplexer 41, the first amplifier 42 and the second amplifier 43 are the same as those of the constituents respectively given the same names in the first exemplary embodiment. The branching unit 45 separates an optical signal amplified by the second amplifier 44 into two optical signals, one of which is directed to a transmission line and the other to the output measurement device 46. For example, an optical coupler is used for the branching unit 45. The output measurement device 46 has an optical channel monitor (OCM) function capable of measuring the intensity of an optical signal in terms of each wavelength, that is, in terms of each channel, and sends the measurement result to the wavelength blocker. The wavelength blocker 44 has a filter function to attenuate a signal outside a predetermined wavelength region, and also has a function to attenuate and adjust an optical signal within the predetermined wavelength region on the basis of the measurement result sent from the output measurement device 46. The wavelength blocker 44 has a variable optical attenuator function capable of demultiplexing an optical signal by means of a diffraction grating or the like and then performing adjustment such as attenuation on each of the signals of respective wavelength. The amount of correction applied by the variable optical attenuator to an optical signal is controlled in a manner to set the signal level after the correction to be a predetermined level, on the basis of the measurement result by the output measurement device 46. The predetermined level is referred to as an output level which is set in advance on the basis of a signal level required for sending out the signal to a transmission line or the like. The predetermined level is set taking into consideration also a decrease of the signal level at the branching unit 45. After the adjustment such as attenuation, the optical signals of respective wavelengths are multiplexed by a diffraction grating or the like, and then outputted from the wavelength blocker 44.

In the demultiplexing unit 30 and the multiplexing unit 40, optical fibers connect between the elements. In a case such as where, in the multiplexing unit 30 and the demultiplexing unit 40, the elements are formed into a single device, connections between the elements may be made not by optical fibers but by another type of optical paths.

A description will be given of operation of the demultiplexing unit in the optical transmission device of the present exemplary embodiment. An optical signal is inputted from a transmission line to the demultiplexing unit 30. The optical signal inputted to the demultiplexing unit 30 is amplified by the amplifier 31, in order to compensate for a loss generated at the transmission line. The optical signal amplified by the amplifier 31 is sent to the demultiplexer 32. The optical signal inputted from the amplifier 31 to the demultiplexer 32 is sent to the arrayed waveguide diffraction grating, where it is demultiplexed in terms of each channel. Thus demultiplexed optical signals of respective channels are guided by the switch elements to paths corresponding to the respective wavelength, and thereby outputted from the demultiplexing unit 30. There may be a case where the optical signals of respective channels are outputted each in a multiplexed state to the respective paths, by comprising a multiplexing element for each of the paths.

There may be a case where, in the demultiplexing unit 30, an optical splitter is used instead of the demultiplexer 32. In that case, an optical signal is not demultiplexed by the demultiplexing unit 30, but is split by the optical splitter into optical signals directed to a plurality of paths and then outputted from the demultiplexing unit 30. In the case where an optical signal is outputted after only being split by the optical splitter, selection of necessary optical signals is performed by such as a wavelength selective switch of a multiplexing unit in an opposing optical transmission device. There may be also a case where a wavelength selective switch or the like is used for the demultiplexer 32.

Next, a description will be given of operation of the multiplexing unit 40 in the optical transmission device of the present exemplary embodiment. Optical signals are inputted from respective paths to the multiplexing unit 40. Out of the optical signals inputted to the multiplexing unit 40, an optical signal is selected by the wavelength selective switch provided in the multiplexer 41, for each of the channels into which the inputted optical signals are demultiplexed, and the selected optical signals are multiplexed together and then outputted. The optical signal thus outputted after being multiplexed is sent to the first amplifier 42, where it is amplified. The optical signal amplified by the first amplifier 42 is sent to the wavelength blocker 43. In the wavelength blocker 43, demultiplexing is performed again in the inside in terms of each wavelength, and a predetermined attenuation process is subsequently performed. The predetermined attenuation process is performed in a manner to obtain a signal level set in advance, on the basis of the measurement result on the signal level by the output measurement device 46. The optical signals having received the attenuation process are multiplexed together again, and then outputted from the wavelength blocker 43.

The optical signal outputted from the wavelength blocker 43 is amplified by the second amplifier 44. The optical signal amplified by the second amplifier 44 is separated by the branching unit 45 into an optical signal to be outputted to a transmission line and an optical signal to be directed to the output measurement device 46. From among the separated optical signals, the optical signal to be outputted to a transmission line is sent to the transmission line after being outputted from the multiplexing unit 40. The optical signal to be directed to the output measurement device 46 is sent to the output measurement device 46. On receiving the optical signal, the output measurement device 46 demultiplexes it into optical signals of respective channels, and measures the intensities of the demultiplexed optical signals by means of photodiodes. The demultiplexing is performed by the use of a diffraction grating such as an arrayed waveguide grating. The intensities of the optical signal thus measured are sent to the wavelength blocker 43 and used as information to be a basis for determining the amount of attenuation in the attenuation process performed by the wavelength blocker 43.

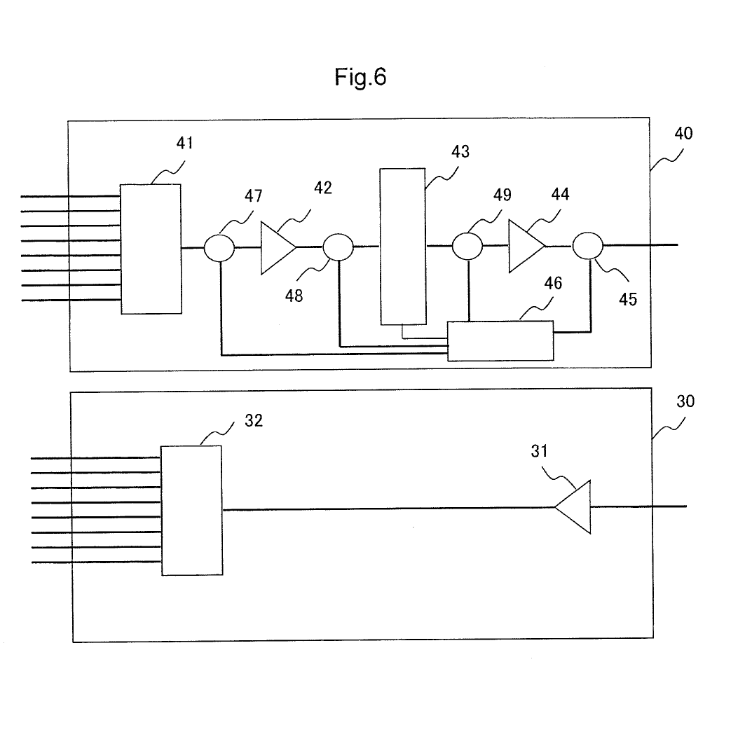

While, in the multiplexing unit 40 of the present exemplary embodiment, the measurement on an optical signal is enabled by the branching unit 45 branching out the optical signal amplified by the second amplifier 44, the number of measurement locations may be increased. For example, as shown in FIG. 6, branching units may be provided at respective gaps among the demultiplexer 41, the first amplifier 42, the wavelength blocker 43 and the second amplifier 44. Optical signals branched out respectively by the branching units 47, 48 and 49, which are provided at respective gaps among the constituents, are sent to the output measurement device 46. For the branching units 47, 48 and 49, elements having the same configuration and function as those of the branching unit 45 may be used. The optical signals sent to the output measurement device 46 are demultiplexed in terms of each channel, similarly to the case of the optical signal branched out by the branching unit 45, and then their intensities are measured. By thus performing measurements at the locations before and after the wavelength blocker 43 and the second amplifier 44, control with additional consideration of the actual attenuation amount for each channel becomes possible, and accuracy of the signal correction is accordingly increased. By thus increasing the number of branching locations for measurement, it also becomes possible to perform control with additional consideration of the influence of a failure, when the failure occurs in any of the constituents.

The constituents of the optical transmission device of the present exemplary embodiment may be formed as individually independent components, and some of them may also be formed together into a single component. When they are formed as individually independent components, by installing them into an integrated component such as into a single circuit board, the accuracy of collaborative operation between the constituents is increased. When the multiplexer 41 and the wavelength blocker 43 are formed as separate components, the effect of installing them into a single substrate or the like becomes particularly large.

By using the optical transmission device of the second exemplary embodiment, it becomes possible to suppress the influence of signal deterioration, such as waveform distortion of an optical signal and deterioration in its OSNR, generated at a time of the signal's passing through a device on a transmission line. In particular, because the level of signal correction is determined by measuring the output level, accuracy of the correction becomes high, and the effect of suppressing the influence of waveform distortion and the like becomes large. As a result, the quality of communication is further increased.

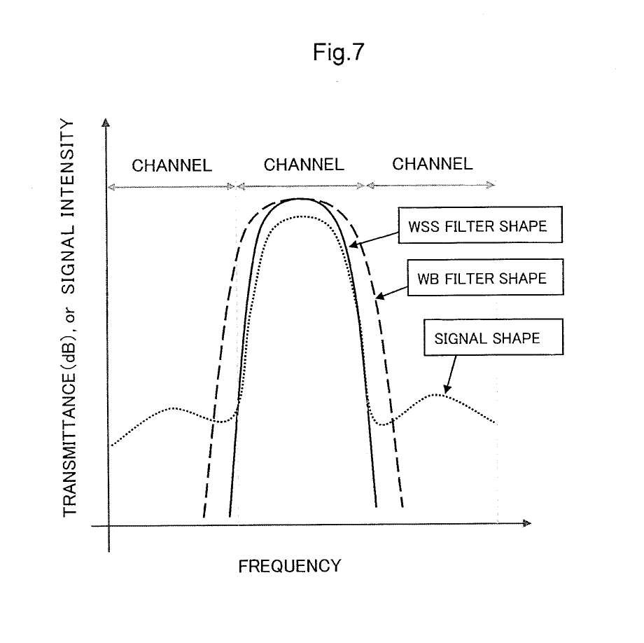

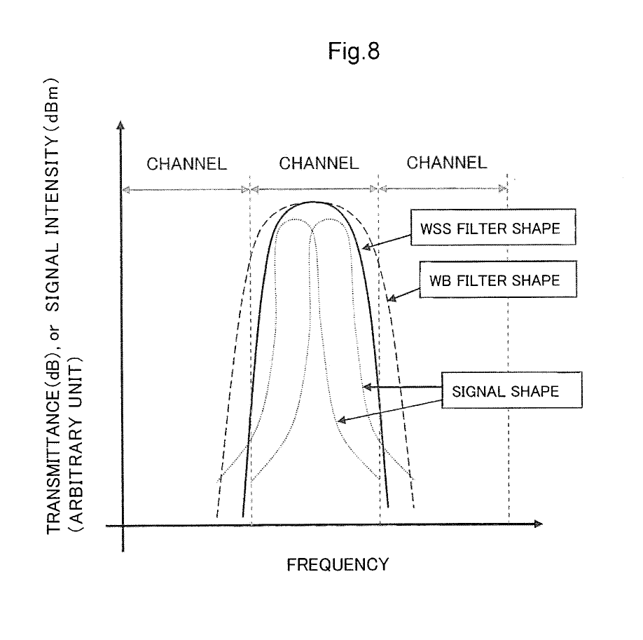

In the optical transmission devices of the first and the second exemplary embodiments of the present invention, because they use the wavelength selective switch and the wavelength blocker, optical signals of respective wavelengths, that is, of respective channels, are subjected to filtering twice. As the spectrum shapes of the optical signals become closer to the filter shapes, there may occur band narrowing because the optical signals are strongly influenced by the filters, and the influence may become larger owing to the two-time filtering. FIG. 7 shows an example of a case where a spectrum of the wavelength selective switch and the spectrum of an optical signal are close to each other. In FIG. 7, the signal shape is close to the WSS filter shape representing a filter characteristic corresponding to that of the wavelength selective switch for one single channel. In that case, the optical signal is likely to be influenced by the filter effect held by the wavelength selective switch. FIG. 8 shows an example of a case referred to as a super channel method where a signal is set to have two or more wavelength peaks in one channel.

In the super channel method, because a large portion of the filter bandwidth is used, the signal is likely in particular to receive influence of the filtering. In order to reduce the influence of filtering, it is preferable to use a wavelength blocker having a wider filter bandwidth than that of the wavelength selective switch. In the examples shown in FIGS. 7 and 8, a WB filter characteristic representing the filter characteristic held by a wavelength blocker is wider in bandwidth than the filter characteristic of a wavelength selector switch. Therefore, the influence of band narrowing is reduced in the cases of the examples in FIGS. 7 and 8. When setting the bandwidth of a wavelength blocker to be wider than that of a wavelength selective switch, it is desirable to set the bandwidth of the wavelength blocker to be more than 20% wider in 0.5 dB bandwidth with reference to the bandwidth of the wavelength selective switch.

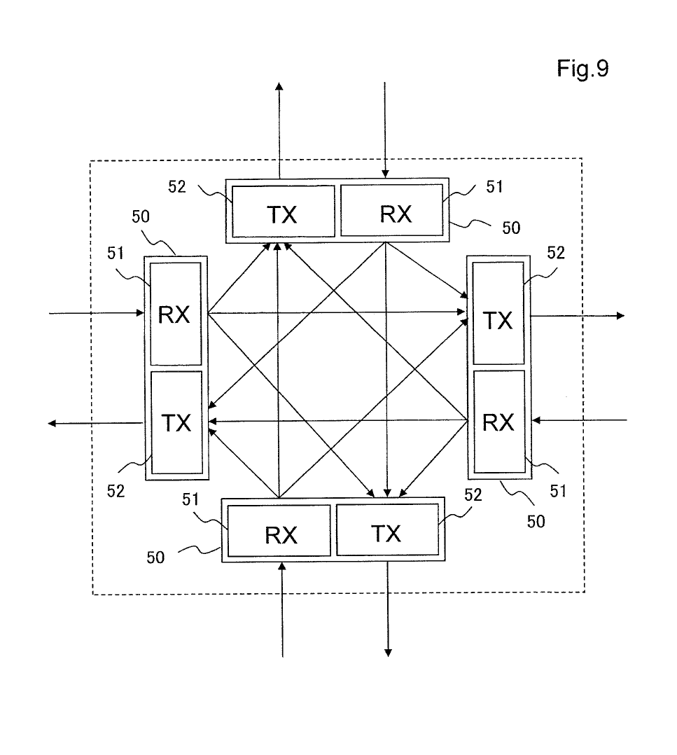

The optical transmission device of the first or the second exemplary embodiments of the present invention can be used, in a form where a plurality of them are combined together, to constitute an optical transmission device having an optical cross-connect function. An optical transmission device having an optical cross-connect function is referred to also as an optical cross-connect device. FIG. 9 is a schematic diagram for when an optical transmission device having an optical cross-connect function is configured using four optical transmission devices of the first or the second exemplary embodiments of the present invention. Each of optical transmission devices 50 consists of a demultiplexing unit 51 and a multiplexing unit 52. Each of the devices receives an optical signal from a transmission line and sends optical signals to paths toward the other devices, by means of the demultiplexing unit 51. The multiplexing unit 52 in each of the optical transmission devices 50 selects and multiplexes together necessary channels from among optical signals sent from the other devices, and sends the multiplexed signal to a transmission line. Because the devices can perform sending and reception of optical signals to and from each other, optical signals coming from respective transmission lines each can be transferred to other ones of the transmission lines after changing their combination. A section for performing the change of combination is referred to as a cross-connect section.

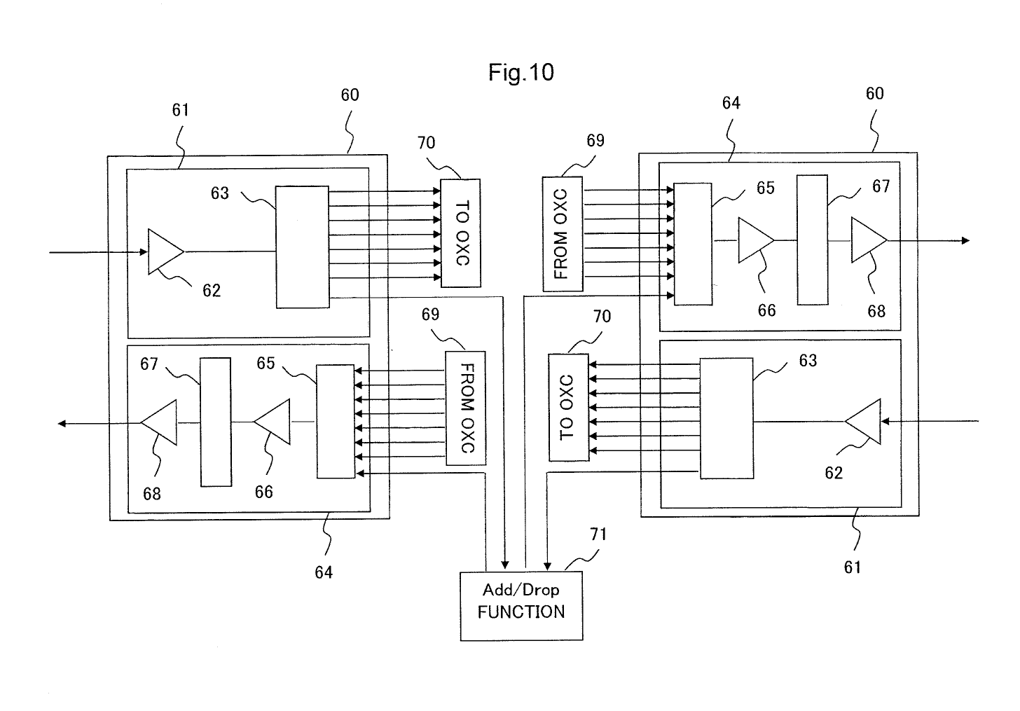

FIG. 10 is a diagram showing an example where the optical transmission device of the first exemplary embodiment is used for two of a plurality of optical transmission devices constituting an optical cross-connect device. Each of optical transmission devices 60 consists of a demultiplexing unit 61 and a multiplexing unit 64. The demultiplexing unit 61 and the multiplexing unit 64 have the same functions as those of the units respectively given the same names in the first exemplary embodiment. The demultiplexing unit 61 consists of an amplifier 62 and a demultiplexer 62. Some of optical signals outputted from the demultiplexer 63 of the demultiplexing unit 61 are dropped and sent to the other devices or to the own device, where information of the optical signals are used. Other ones of the optical signals outputted from the demultiplexing unit 61 are sent to a cross-connect section. In FIG. 10, optical signals to be sent to the cross-connect section is expressed as a signal group 70 directed to the cross-connect section. The multiplexing unit 64 consists of a multiplexer 65, a first amplifier 66, a wavelength blocker 67 and a second amplifier 68. To the multiplexer 65 of the multiplexing unit 64, a signal group 69 from the cross-connect section is inputted. At that time, one or more optical signals may be added from the other devices or the own device. In the multiplexer 65, the added optical signals and the optical signals from the cross-connect section are multiplexed together.

In FIG. 10, a function by which optical signals are received or sent by the other devices or the own device is represented by an add/drop function section 71. Employing the configuration described above, it is possible to constitute an optical add/drop multiplexer by combining a plurality of the optical transmission devices of the first exemplary embodiment. Although FIG. 10 shows only an example where the optical transmission device of the first exemplary embodiment is used, the optical transmission device of the second exemplary embodiment may also be used, and both of the first and the second ones may also be used. Further, a configuration of the optical add/drop multiplexer may comprise an optical transmission device other than those of the first and the second exemplary embodiments. By using the optical transmission device of the first or the second exemplary embodiments, an optical add/drop multiplexer with small influence of signal deterioration can be obtained.

The optical transmission devices of the first and the second exemplary embodiments of the present invention can be used for a device capable of dynamically changing paths for cross-connect and for add/drop. The device capable of dynamically changing paths for add/drop is sometimes referred to as a ROADM (Reconfigurable Optical Add/Drop Multiplexer).

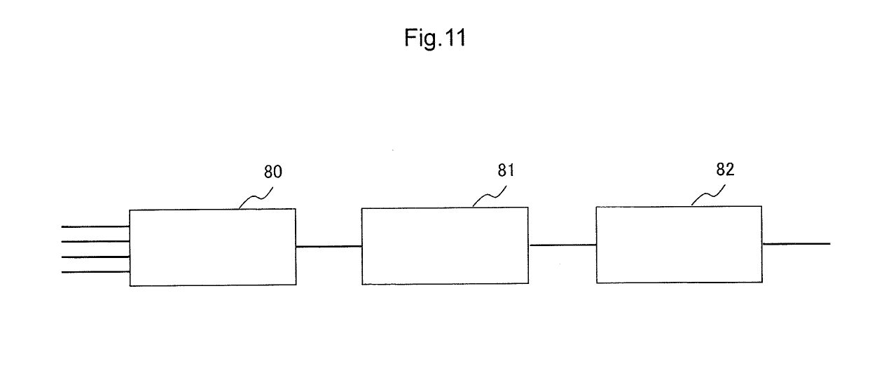

Next, a third exemplary embodiment of the present invention will be described in detail, with reference to FIG. 11. FIG. 11 is a diagram showing an outline of a configuration of an optical transmission device of the third exemplary embodiment.

The optical transmission device of the present exemplary embodiment comprises a multiplexing means 80, an amplification means 81 and an optical signal correction means 82. The multiplexing means 80 multiplexes optical signals inputted to it by means of paths corresponding to respective channels of the optical signals, and outputs thus produced signal as a multiplexed signal. The amplification means 81 amplifies the multiplexed signal and outputs thus produced signal as an amplified signal. The optical signal correction means 82 performs correction of the amplified signal in terms of each channel and outputs thus produced signal as a corrected signal.

The optical transmission device of the present exemplary embodiment uses the multiplexing means comprising paths corresponding respectively to wavelength of an optical signal, the amplification means, and the optical signal correction means for correction in terms of each channel, in this order. Inputting a signal to the means in that order, it is possible to suppress the influence of signal deterioration such as waveform distortion of an optical signal and deterioration in its OSNR. This effect is brought about by removing noise or the like included in an optical signal by means of a filtering characteristic realized by the multiplexing means having paths corresponding to respective wavelengths, amplifying the optical signal in a state the noise or the like has been removed, and further performing correction of the optical signal. By performing correction of a signal in a state with a smaller amount of noise, accuracy of the signal correction is increased. As a result, the influence of accumulation of noise or the like at a time of an optical signal's passing through the optical transmission device is decreased, it accordingly becomes possible to transmit an optical signal in a state where waveform distortion of the optical signal, deterioration in its OSNR and the like are small, and the quality of communication is accordingly increased.

Part or the whole of the exemplary embodiments described above can be described also as, but not limited to, the following supplementary notes.

(supplementary note 1) An optical transmission device characterized by comprising: a multiplexing means for multiplexing optical signals inputted to it, by means of paths in accordance with respective channels, and outputting thus produced signal as a multiplexed signal; an amplification means for amplifying the multiplexed signal and outputting thus produced signal as an amplified signal; and an optical signal correction means for performing correction of the amplified signal in terms of each channel and outputting thus produced signal as a corrected signal.

(supplementary note 2) The optical transmission device according to supplementary note 1, characterized by that the optical signal correction means is a means for correcting the intensity of an optical signal in terms of each channel.

(supplementary note 3) The optical transmission device according to any one of supplementary notes 1 and 2, characterized by that the optical signal correction means comprises a wavelength blocker, wherein the wavelength blocker is an element for receiving the amplified signal inputted to the optical signal correction means and outputting the corrected signal.

(supplementary note 4) The optical transmission device according to any one of supplementary notes 1 to 3, characterized by that the multiplexing means comprises a wavelength selective switch, wherein the wavelength selective switch is an element for outputting the optical signals inputted to the multiplexing means as the multiplexed signal.

(supplementary note 5) The optical transmission device according to any one of supplementary notes 1 to 4, characterized by further comprising: a branching means for separating the corrected signal into a first signal and a second signal; a means for outputting the first signal to a transmission line; and an output measurement means for measuring the intensity of the second signal, wherein the correction means further comprises a means for correcting a signal on the basis of a result of the measurement of the second signal.

(supplementary note 6) The optical transmission device according to supplementary note 5, characterized by further comprising a secondary branching means for branching out an optical signal at least at either of the gap between the multiplexing means and the amplification means and the gap between the amplification means and the optical signal correction means, wherein the output measurement means further comprises a means for measuring the intensity of an optical signal branched out by the secondary branching means, and the correction means further comprises a means for correcting the intensity of a signal on the basis of a result of the measurement of the intensity of an optical signal branched out by the secondary branching means.

(supplementary note 7) The optical transmission device according to any one of supplementary notes 1 to 6, characterized by that a bandwidth of optical signal transmission by the paths in accordance with respective channels comprised in the multiplexing means is wider than a bandwidth of optical signal transmission by the paths in accordance with respective channels comprised in the optical signal correction means.

(supplementary note 8) The optical transmission device according to any one of supplementary notes 1 to 7, characterized by that the multiplexing means and the optical signal correction means are installed into a single circuit board.

(supplementary note 9) The optical transmission device according to supplementary note 8, characterized by that the multiplexing means and the optical signal correction means are each formed as an independent component.

(supplementary note 10) An optical add/drop multiplexer, characterized by comprising a plurality of optical transmission devices according to any one of supplementary notes 1 to 9, wherein some or all of output signals outputted from one of the optical transmission device are inputted to the multiplexing means of other ones of the optical transmission devices.

(supplementary note 11) an optical signal transmission method, characterized by comprising: multiplexing inputted optical signals by means of paths in accordance with respective channels of the optical signals and outputting thus produced signal as a multiplexed signal; amplifying the multiplexed signal and outputting thus produced signal as an amplified signal; and performing correction of the amplified signal in terms of each channel and outputting thus produced signal as a corrected signal.

(supplementary note 12) The optical signal transmission method according to supplementary note 11, characterized by further comprising: branching out part of the corrected signal as a signal to be measured; measuring the intensity of the signal to be measured; and performing correction of the amplified signal on the basis of a result of the measurement.

The present invention has been described above with reference to exemplary embodiments, but the present invention is not limited to the above-described exemplary embodiments. To the configurations and the details of the present invention, various changes which can be understood by those skilled in the art may be made within the scope of the present invention.

This application is based upon and claims the benefit of priority from Japanese Patent Application No. 2012-164258, filed on Jul. 25, 2012, the disclosure of which is hereby incorporated in its entirety by reference.

### INDUSTRIAL APPLICABILITY

The present invention can be used for an optical transmission device in the field of optical telecommunications. In particular, the present invention is suitable for an optical transmission device constituting an optical add/drop multiplexer or the like.

### REFERENCE SIGNS LIST

10 multiplexing unit
11 multiplexer
12 first amplifier
13 wavelength blocker
14 second amplifier
20 demultiplexing unit
21 amplifier
22 demultiplexer
30 demultiplexing unit
31 amplifier
32 demultiplexer
40 multiplexing unit
41 multiplexer
42 first amplifier
43 wavelength blocker
44 second amplifier
45 branching unit
46 output measurement device
47 branching unit
48 branching unit
49 branching unit
50 optical transmission device
51 demultiplexing unit
52 multiplexing unit
60 optical transmission device
61 demultiplexing unit
62 amplifier
63 demultiplexer
64 multiplexing unit
65 multiplexer
66 first amplifier
67 wavelength blocker
68 second amplifier
69 signal group from cross-connect section
70 signal group to cross-connect section
71 add/drop function section
80 multiplexing means
81 amplification means
82 optical signal correction means
100 demultiplexing element
101 switch element
102 multiplexing element
103 first diffraction grating
104 variable optical attenuator unit
105 second diffraction grating

1. An optical transmission device, comprising:
a multiplexing unit which multiplexes optical signals inputted to it, by means of paths in accordance with respective channels, and outputting thus produced signal as a multiplexed signal;
an amplification unit which amplifies the multiplexed signal and outputting thus produced signal as an amplified signal; and
an optical signal correction unit which perform correction of the amplified signal in terms of each channel and outputting thus produced signal as a corrected signal.

2. The optical transmission device according to claim 1, wherein the optical signal correction unit is a unit which corrects the intensity of an optical signal in terms of each channel.

3. The optical transmission device according to claim 1, wherein:
the optical signal correction unit comprises a wavelength blocker; and
the wavelength blocker is an element for receiving the amplified signal inputted to the optical signal correction unit and outputting the corrected signal.

4. The optical transmission device according to claim 1, wherein:
the multiplexing unit comprises a wavelength selective switch; and
the wavelength selective switch is an element for outputting the optical signals inputted to the multiplexing unit as the multiplexed signal.

5. The optical transmission device according to claim 1, further comprising:
a branching unit for separating the corrected signal into a first signal and a second signal;
a unit for outputting unit which outputs the first signal to a transmission line; and
an output measurement unit which measures the intensity of the second signal, wherein
the correction unit further comprises a unit which corrects a signal on the basis of a result of the measurement of the second signal.

6. The optical transmission device according to claim 5, further comprising
a secondary branching unit which branches out an optical signal at least at either of the gap between the multiplexing unit and the amplification unit and the gap between the amplification unit and the optical signal correction unit, wherein:
the output measurement unit further comprises a unit which measures the intensity of an optical signal branched out by the secondary branching unit; and
the correction unit further comprises a unit which corrects the intensity of a signal on the basis of a result of the measurement of the intensity of an optical signal branched out by the secondary branching unit.

7. The optical transmission device according to claim 1, wherein a bandwidth of optical signal transmission by the paths in accordance with respective channels comprised in the multiplexing unit is wider than a bandwidth of optical signal transmission by the paths in accordance with respective channels comprised in the optical signal correction unit.

8. The optical transmission device according to claim 1, wherein the multiplexing unit and the optical signal correction unit are installed into a single circuit board.

9. The optical transmission device according to claim 8, wherein the multiplexing unit and the optical signal correction unit are each formed as an independent component.

10. An optical add/drop multiplexer, comprising
a plurality of optical transmission devices according to claim 1, wherein
some or all of output signals outputted from one of the optical transmission device are inputted to the multiplexing unit of other ones of the optical transmission devices.

11. An optical signal transmission method, comprising:
multiplexing inputted optical signals by means of paths in accordance with respective channels of the optical signals and outputting thus produced signal as a multiplexed signal;
amplifying the multiplexed signal and outputting thus produced signal as an amplified signal; and
performing correction of the amplified signal in terms of each channel and outputting thus produced signal as a corrected signal.

12. The optical signal transmission method according to claim 11, further comprising:
branching out part of the corrected signal as a signal to be measured;
measuring the intensity of the signal to be measured; and
performing correction of the amplified signal on the basis of a result of the measurement.
